(19) United States
(12) Patent Application Publication
(10) Pub. No.: US 2016/0238895 A1
(43) Pub. Date: Aug. 18, 2016

(54) BACKLIGHT UNIT AND LIQUID CRYSTAL DISPLAY INCLUDING THE SAME

(71) Applicant: Samsung Display Co., Ltd, Yongin-si (KR)

(72) Inventors: Kwang-Wook CHOI, Osan-si (KR); Young-Min PARK, Hwaseong-si (KR); Sang Ho HWANG, Suwon-si (KR)

(21) Appl. No.: 14/966,789

(22) Filed: Dec. 11, 2015

(30) Foreign Application Priority Data
Feb. 12, 2015 (KR) 10-2015-0021679

(51) Int. Cl. G02F 1/1335

(52) U.S. Cl. CPC G02F 1/133606; G02F 1/133605; G02F 1/133608; G02F 1/133603

(57) ABSTRACT

A backlight unit according to an exemplary embodiment of the present disclosure includes: a bottom chassis; a light source disposed on the bottom chassis; a reflective sheet disposed on the bottom chassis; at least one optical sheet disposed above the light source and the reflective sheet; and a supporter fixed to the bottom chassis and supporting the optical sheet. The supporter includes a locking portion fastened to the bottom chassis and a supporting portion extending from the locking portion, and the locking portion is positioned lower than the reflective sheet.

### CROSS-REFERENCE TO RELATED APPLICATION

This application claims priority to and the benefit of Korean Patent Application No. 10-2015-0021679 filed in the Korean Intellectual Property Office on Feb. 12, 2015, the entire contents of which are incorporated herein by reference.

### BACKGROUND

(a) Technical Field

The present disclosure relates to a backlight unit and a liquid crystal display (LCD) including the same.

(b) Description of the Related Art

A liquid crystal display (LCD) is a widely used type of display device at present. Generally, the LCD includes a liquid crystal material filled between an upper substrate formed with common electrodes, color filters, and the like, and a lower substrate formed with thin film transistors, pixel electrodes, and the like. By applying different voltages to the pixel and common electrodes to generate an electric field, thereby changing the arrangement of liquid crystal molecules, the LCD is able to adjust the transmittance of light to display an image.

An LCD panel of the LCD is a non-emissive type of light receiving element, so the LCD generally includes a backlight unit for supplying light to the LCD panel at a rear side thereof.

As a light source for the backlight unit, a cold cathode fluorescent lamp (CCFL) and a light emitting diode (LED) are generally used. Conventionally, the CCFL has been widely used as a light source for the backlight unit since it consumes less power and provides bright white light. However, the LED has recently been gaining popularity since it provides superior color reproducibility, a longer lifespan, and less power consumption.

The backlight unit may be classified as an edge type or a direct type, depending on where the light source is positioned in relation to the LCD panel. In the edge type, the light source is positioned at sides of the LCD panel to provide light through a light guide, whereas in the direct type, the light source is positioned at a rear side of the LCD panel to provide light thereto. Among them, the direct type of backlight unit has merits, such as, high light utilization, easy handling, no limitation in size, and a relatively cheaper price.

When a point light source, such as the LED, is used as the light source of the direct type of backlight unit, an optical lens may be provided on a light emitting surface of an LED package, such that the LED light's property of a straight-line propagation is not concentrated on an upper part of a light emitting surface, but is uniformly distributed across the entire LCD panel. Typically, a reflective sheet is positioned below the optical lens to reflect light, and a diffuser is positioned above the optical lens to uniformly distribute light.

The above information disclosed in this Background section is only to enhance the understanding of the background of the disclosure and therefore may contain information that does not form the prior art that is already known in this country to a person of ordinary skill in the art.

### SUMMARY

An objective of the present disclosure is to provide a backlight unit that uniformly supplies light to an LCD panel by improving local luminance increases or decreases and a display device including the same.

A backlight unit according to an exemplary embodiment of the present disclosure includes: a bottom chassis; a light source disposed on the bottom chassis; a reflective sheet disposed on the bottom chassis; at least one optical sheet disposed above the light source and the reflective sheet; and a supporter fixed to the bottom chassis and supporting the optical sheet. The supporter includes a locking portion fastened to the bottom chassis and a supporting portion extending from the locking portion, and the locking portion is positioned lower than the reflective sheet.

The locking portion may include a supporting plate positioned between the bottom chassis and the reflective sheet, and a hook penetrating the bottom chassis to be at least partially positioned below the bottom chassis.

The bottom chassis may include a substantially flat base portion and a recess downwardly depressed further than the base portion, in which recess the supporting plate is positioned, and a depth of the recess may be the same as or greater than a thickness of the supporting plate.

A top surface of the supporting plate may be positioned at the same height as or lower than a top surface of the base portion.

The reflective sheet may include a hole through which the support portion passes.

The backlight unit may further include a substrate on which h the light source is mounted, wherein the substrate may be fixed to the bottom chassis and positioned lower than the reflective sheet.

The bottom chassis may include a substantially flat base portion and a groove downwardly depressed further than the base portion, in which groove the substrate is positioned, and a depth of the groove is the same as or greater than a thickness of the substrate.

A top surface of the substrate may be positioned at the same height as or lower than a top surface of the base portion.

The reflective sheet may be attached to the substrate through an adhesive.

The backlight unit may further include a side emitting lens attached to the substrate and positioned to cover the light source.

The optical sheet may include a diffuser.

A manufacturing method of a backlight unit according to an exemplary embodiment of the present disclosure includes: preparing a bottom chassis; fixing a light source unit including a light source to the bottom chassis; fixing a supporter to the bottom chassis such that the supporter supports at least one optical sheet; and placing a reflective sheet on the bottom chassis by using at least a portion of the supporter as a guide after fixing the supporter.

The supporter may include a locking portion fastened to the bottom chassis and a supporting portion extending from the locking portion, the reflective sheet may include a hole that is formed at a corresponding position of the support portion, and the placing of the reflective sheet on the bottom chassis may include fitting the hole into the support portion.

The light source unit may include a substrate and a light source mounted on the substrate, and the placing of the reflective sheet on the bottom chassis may include attaching the reflective sheet to the substrate.

A display device according to an exemplary embodiment of the present disclosure includes: a display panel; and a backlight unit for supplying light to the display panel. The backlight unit includes: a bottom chassis; a light source disposed on the bottom chassis; a reflective sheet disposed on the bottom chassis; at least one optical sheet disposed above the light source and the reflective sheet; and a supporter fixed to the bottom chassis and supporting the optical sheet. The supporter includes a locking portion fastened to the bottom chassis and a supporting portion extending from the locking portion, and the locking portion is disposed lower than the reflective sheet.

The locking portion may include a supporting plate positioned between the bottom chassis and the reflective sheet, and a hook penetrating the bottom chassis to be at least partially positioned below the bottom chassis.

The bottom chassis may include a substantially flat base portion and a recess downwardly depressed further than the base portion, in which recess the supporting plate is positioned, and a depth of the recess is the same as or greater than a thickness of the supporting plate.

A top surface of the supporting plate may be positioned at the same height as or lower than a top surface of the base portion.

The reflective sheet may include a hole through which the support portion passes.

The backlight unit may further include a substrate on which the light source is mounted, and the substrate may be fixed to the bottom chassis and positioned lower than the reflective sheet.

The bottom chassis may include a substantially flat base portion and a groove downwardly depressed further than the base portion, in which groove the substrate is positioned, and a depth of the groove may be the same as or greater than a thickness of the substrate.

A top surface of the substrate may be positioned at the same height as or lower than a top surface of the base portion.

The reflective sheet may be attached to the substrate through an adhesive.

The backlight unit may further include a side emitting lens attached to the substrate and positioned to cover the light source.

The optical sheet may include a diffuser.

The backlight unit according to the present disclosure minimizes exposure of the supporter in an optical space, so unnecessary light scattering due to the supporter is minimized, which improves a profile of the light emitted from the backlight unit.

In addition, the supporter can be used as the guide for assembling the reflective sheet, so an additional means is not required to assemble the reflective sheet at a proper position, and local luminance deterioration does not occur due to such an additional means.

### BRIEF DESCRIPTION OF THE DRAWINGS

FIG. 1 is an exploded perspective view of a liquid crystal display (LCD) including a backlight unit according to an exemplary embodiment of the present disclosure.

FIG. 2 is a cross-sectional view of FIG. 1 taken along the line A-A.

FIG. 3 is an enlarged partial cross-sectional view of FIG. 2.

FIGS. 4A and 4B are perspective views of supporters according to exemplary embodiments of the present disclosure.

FIGS. 5, 6, 7, 8 and 9 are schematic diagrams for illustrating an assembly process of a backlight unit according to an exemplary embodiment of the present disclosure.

FIGS. 10 and 11 are drawings that illustrate light reflectance and a luminance profile of the backlight unit according to an exemplary embodiment of the present disclosure.

FIGS. 12 and 13 are drawings that illustrate light reflectance and a luminance profile of a backlight unit according to a comparative example.

FIG. 14 is a drawing that illustrates a luminance distribution of light emitted from the backlight unit according to an exemplary embodiment of the disclosure.

FIG. 15 is a graph illustrating a luminance profile of a B-B region of FIG. 14 together with that of a comparative example.

### DETAILED DESCRIPTION OF THE EMBODIMENTS

The present system and method are described more fully hereinafter with reference to the accompanying drawings in which exemplary embodiments of the present system and method are shown. As those skilled in the art would realize, the described embodiments may be modified in various different ways, all without departing from the spirit or scope of the present system and method.

In the drawings, the thickness of layers, films, panels, regions, etc. are enlarged or exaggerated for clarity. It will be understood that when an element, such as, a layer, film, region, or substrate is referred to as being “on” another element, it may be directly on the other element, or intervening elements may also be present. In contrast, when an element is referred to as being “directly on” another element, there are no intervening elements present.

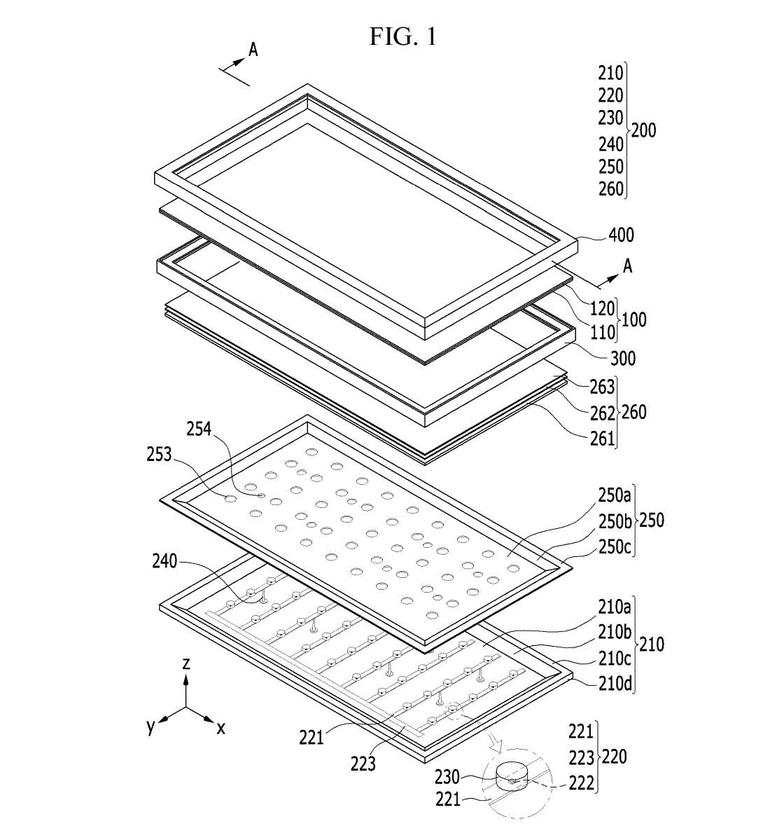

A liquid crystal display (LCD) including a backlight unit according to an exemplary embodiment of the present disclosure is described in detail with reference to FIGS. 1 to 4.

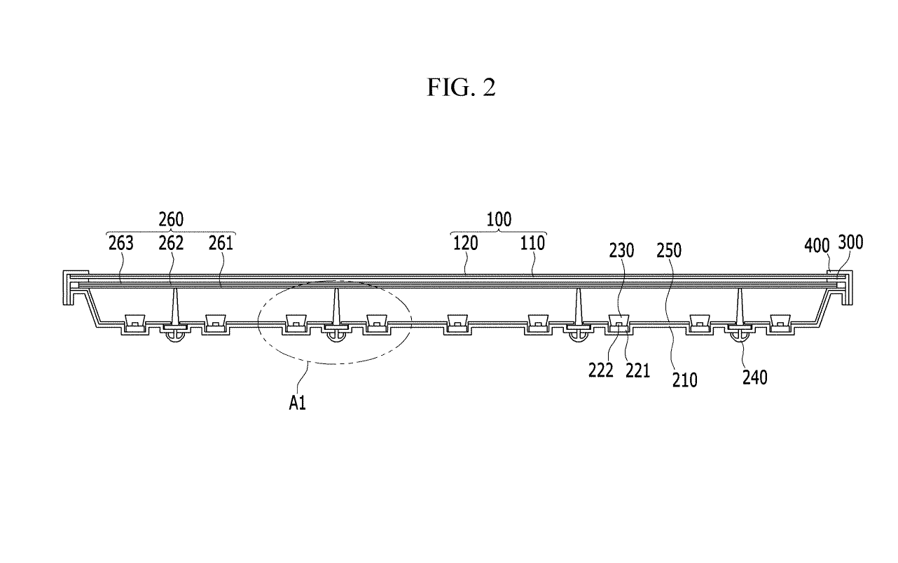

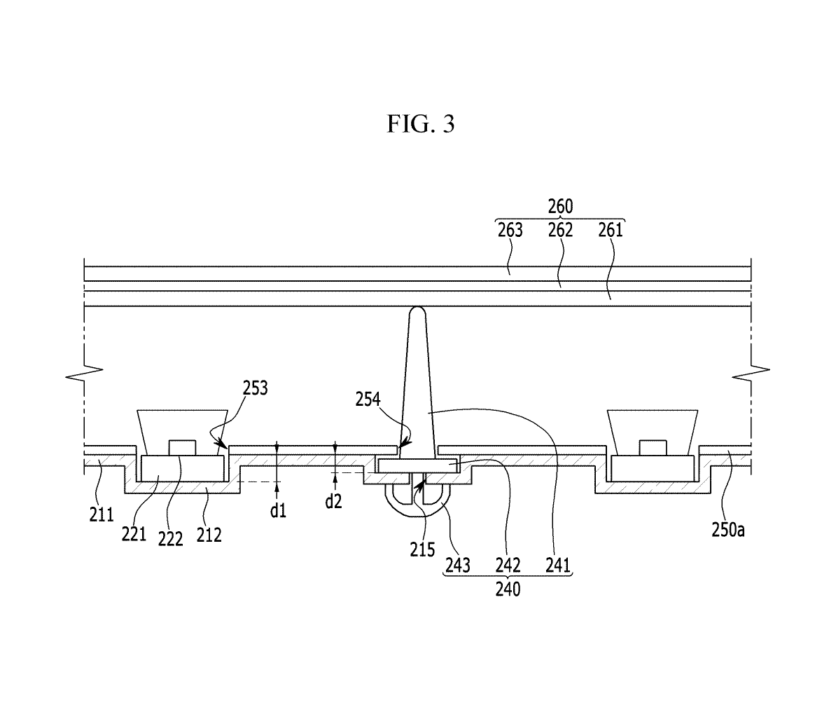

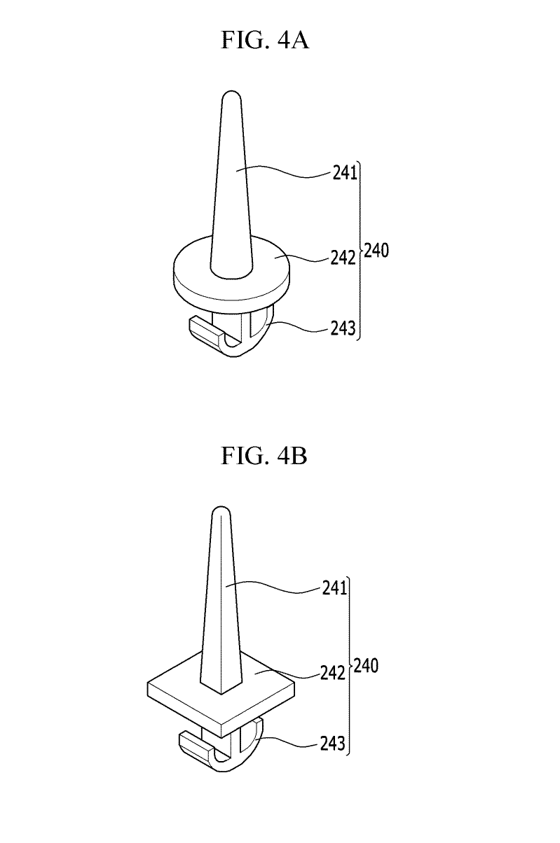

FIG. 1 is an exploded perspective view of a liquid crystal display (LCD) including a backlight unit according to an exemplary embodiment of the present disclosure. FIG. 2 is a cross-sectional view of FIG. 1 taken along the line A-A. FIG. 3 is an enlarged cross-sectional view of a part of FIG. 2. FIGS. 4A and 4B are perspective views of supporters according to exemplary embodiments of the present disclosure.

Referring to FIGS. 1 and 2, the LCD includes an LCD panel 100 and backlight unit 200

The backlight unit 200 supplies light to the LCD panel, and the LCD panel 100 displays an image by controlling the supplied light. The LCD further includes a mold frame 300 that is positioned between the LCD panel 100 and the backlight unit 200. The LCD further includes a top chassis 400 that protects the LCD panel 100 while enclosing a rim thereof and prevents the LCD panel 100 from being separated from the backlight unit 200. In some exemplary embodiments, either one or both of the mold frame 300 and the top chassis 400 may be omitted.

The LCD panel 100 includes a lower display substrate 110, an upper display substrate 120, and a liquid crystal layer (not shown). The lower display substrate 110 and the upper display substrate 120 are attached to each other while maintaining a predetermined interval therebetween where the liquid crystal layer is formed.

The lower display substrate 110 includes a transparent insulation substrate, such as glass, and a plurality of thin film transistors, data lines, gate lines, pixel electrodes, etc. that are formed on the insulation substrate. A data line is connected to a source terminal of a thin film transistor, and a gate line is connected to a gate terminal thereof. A pixel electrode formed of a transparent conductive material, such as indium tin oxide (ITO), is connected to a drain terminal of the thin film transistor.

The upper display substrate 120 is positioned to face the lower display substrate 110 and includes a transparent insulation substrate on which color filters, common electrodes, etc. are formed. Each of the color filters may represent a primary color, such as red, green, and blue. A common electrode is formed of a transparent conductive material, such as indium tin oxide (ITO) or indium zinc oxide (IZO). In some embodiments, at least one of the color filter and the common electrode may be positioned in the lower display substrate 110 instead.

Polarizers may be attached to the lower display substrate 110 and the upper display substrate 120, respectively. The polarizers may polarize incident light on the LCD panel 100 to transmit only light vibrating in one direction. In the LCD panel 100, when the thin film transistor is turned on by a signal applied to the gate line, a signal applied to the data line is applied to the pixel electrode, which causes an electric field to be generated between the pixel electrode and the common electrode. The intensity of the electric field is based on the voltage level of the signal applied to the pixel electrode. By controlling the voltage level, and thereby the intensity of the electric field, the alignments of liquid crystal molecules of the liquid crystal layer may be controlled to change the polarization direction of incident light by the liquid crystal layer. The combined polarization effects of the liquid crystal layer and the polarizers determine the transmittance thereof. Accordingly, transmittance of light passing through the liquid crystal layer and the polarizers may be controlled to display an image.

The LCD includes at least one driving device (not shown), such as a driver and a controller, that controls signals applied to the LCD panel 100. As an IC chip, the driving device may be mounted on the LCD panel 100 or on a printed circuit board (PCB) and a flexible printed circuit board (FPCB) to be electrically connected to the LCD panel 100. Some driving devices may be integrated into the LCD panel 100.

The backlight unit 200 is positioned below the LCD panel 100 to supply light to the LCD panel 100.

The backlight unit 200 includes a bottom chassis 210, a light source unit 220 that is accommodated in and fixed to or supported by the bottom chassis 210, an optical lens 230, a supporter 240, a reflective sheet 250, and an optical sheet 260.

The bottom chassis 210 is a kind of container with its upper surface open and an accommodating space having a predetermined depth. For example, the bottom chassis 210 may have an overall quadrangular tray-like shape. The bottom chassis 210 includes a bottom 210a, a wing 210b extending from edges of the bottom 210a in a substantially slanted and upward direction, and a rim 210c extending from an upper end of the wing 210b in a substantially parallel and outward direction (e.g., parallel to the bottom 210a). The bottom 210a includes a substantially flat base portion 211, and a groove 212 and a recess 214 downwardly depressed further than the base portion 211 (in a negative z direction). The bottom chassis 210 may further include a wall 210d that downwardly extends from the rim 210c. A height from the bottom 210a to the rim 210c corresponds to a depth of the bottom chassis 210. The accommodating space defined by the bottom 210a and the wing 210b of the bottom chassis 210 may have a cross-section of an overall reverse trapezoid.

The bottom chassis 210 may be formed of a metallic material such as an aluminum plate, an aluminum alloy plate, or zinc-plated steel. In some exemplary embodiments, the bottom chassis 210 may be formed of a plastic material such as polycarbonate (PC).

The light source unit 220 is accommodated in the bottom chassis 210. The light source unit 220 includes a substrate 221, and a light source 222 mounted thereon. The light source 222, which may be a light emitting diode (LED) package, is mounted on the circuit board 221 such that a light emitting surface of the light source 222 faces the LCD panel 100. A white LED package for emitting white light may be used as the LED package, or a mixed arrangement of red, green, and blue LED packages may also be used. In addition to the LED packages, other point or line light sources may be used as the light source 222.

The substrate 221 may have a narrow elongated bar shape. The substrate 221 supplies power to and supports the light source 222. The substrate 221 may be a circuit board, for example, a metal core printed circuit board (MCPCB) that quickly discharges heat generated from the light source 222. The light source 222 is electrically connected to wires of the substrate 221 to receive power, and converts electrical energy into light energy to emit light. One or more light sources 222 may be disposed on one substrate 221. The total number of the light sources 222 and their arrangement may be modified in various ways depending on the size of the LCD panel, the output of the light source, etc.

The optical lens 230 is also mounted on the substrate 221. The optical lens 230 is positioned to substantially cover the light source 222, so light emitted from the light source 222 is refracted and diffused through the optical lens 230. Since the optical lens 230 diffuses the light directed upward of the light source 222, such that it is not concentrated, the optical lens 230 may be used to reduce the number of the light sources 222 and to apply a high power light source.

The optical lens 230 may be a side emitting lens that refracts and diffuses the light directed upward of the light source 222 mostly in side directions. The optical lens 230 may be a top emitting lens that refracts and diffuses the light of the light source 222 mostly in an upward direction. Since the side emitting lens may reduce an optical path further than the top emitting lens, the optical sheet 260, as described later, may be positioned closer to the light source 222, so an overall thickness of the backlight unit 200 may be reduced to realize a slimmer LCD.

The substrate 221, the light source 222, and the optical lens 230 together are referred to as a light source assembly in the present specification. A plurality of light source assemblies may be disposed at the bottom 210a of the bottom chassis 210 at predetermined intervals, and the number of the light source assemblies is the same as that of the substrates 221. As illustrated in FIG. 3, the light source assembly is mounted on the groove 212 of the bottom 210a. A depth d1 of the groove 212 may be greater than a thickness of the substrate 221 such that the substrate 221 of the light source assembly is positioned at the same height as or lower than the base portion 211 that forms an overall flat surface of the bottom 210a. Accordingly, when viewed in a cross-section, a top surface of the substrate 221 is positioned at the same height as or lower than the top surface of the base portion 211. As a result, the reflective sheet 250, as described later, is prevented from protruding or being lifted near the light source assembly. That is, when the reflective sheet 250 is attached to the substrate 221, the top surfaces of the substrate 221 and the base portion 211 may be positioned nearly at the same height to prevent the reflective sheet 250 from being lifted. If there is a height difference between them, an attached portion of the reflective sheet 250 may not be smooth.

When the plurality of light source assemblies are disposed as illustrated, the light source unit 220 may further include one or a plurality of connecting boards 223 for supplying power to each of the light source assemblies. The plurality of light source assemblies may be connected to the connecting board 223. For example, an end portion of the substrate 221 may be inserted into an insertion hole (not shown) of the connecting board 223 to be connected thereto, like a plug. The bottom 210a may include a groove (not shown) for mounting the connecting board 223 such that the connecting board 223 is positioned at the same height as or lower than the base portion 211 of the bottom 210a. In some exemplary embodiments, instead of the connecting board 223, electric wires may be used to supply power to the light source assembly.

The supporter 240 for supporting the optical sheet 260 is disposed on the bottom chassis 210. A plurality of supporters 240 may be disposed at the bottom 210a of the bottom chassis 210 at predetermined intervals. The supporter 240 includes a locking portion (242, 243) that is locked to the bottom chassis 210, and a supporting portion 241 that extends upwardly therefrom. Accordingly, the supporter 240 is secured to the bottom chassis 210, and the supporting portion 241 protrudes upwardly from the bottom chassis 210 with a predetermined height.

The supporter 240 may be formed of a plastic, such as a polycarbonate or a metal, and may be formed as a single component. The supporter 240 may be coated with an optical material, such as a light absorptive material, to minimize light scattering or reflection by the supporter 240.

As a kind of pillar for substantially supporting the optical sheet 260, the supporting portion 241 has a smaller cross-section than the supporting plate 242 and extends straight therefrom. An upper end of the supporting portion 241 may contact the optical sheet 260 to support the optical sheet 260 and prevent the optical sheet 260 from drooping and to maintain the optical path between the light source 222 and the optical sheet 260.

The supporting portion 241 may have a thin, elongated shape (e.g., circular cylindrical or polygonal shape) to minimize the light scattering and reflection due to the supporting portion 241, and may have a shape in which its cross-sectional area gradually decreases towards its upper end. The supporting portion 241 may have, for example, a conical shape, as illustrated in FIG. 4A, or a polypyramidal shape, such as, a triangular pyramid, a quadrangular pyramid (refer to FIG. 4B), etc. However, the end portion of the supporting portion 241 where it directly contacts the optical sheet 260 may be formed to be round or flat.

The locking portion serves to stably fix the supporting portion 241 to the bottom chassis 210, so that the supporting portion 241 supports the optical sheet 260 at a proper position. The locking portion may include the supporting plate 242 contacting the top surface of the bottom chassis 210, and the hook 243 contacting the bottom surface of the bottom chassis 210. In order for, The bottom chassis 210 includes a penetration hole 215 through which the hook 243 may pass through to contact the bottom surface of the bottom chassis 210 to be fixed thereto. The hook 243 may be elastically restored after passing through the penetration hole 215. Thus, the supporter 240 is fastened to the bottom chassis 210 by sandwiching the bottom chassis 210 between the supporting plate 242 and the hook 243. The shape of the hook 243 illustrated in the drawings is only exemplarily provided and may be variously modified.

In some embodiments, the supporting plate 242 secures a wide contact area with the bottom chassis 210 such that the supporter 240 does not shake and is stably fastened. Accordingly, the supporting plate 242 may have a flat shape, and may be a circular plate or a polygonal plate, such as, for example, a quadrangular plate, a pentagonal plate, or the like.

The supporter 240 is fastened to position the supporting plate 242 in the recess 214 of the bottom 210a of the bottom chassis 210. The penetration hole 215 is formed at a center of the recess 214, and the hook 243 of the supporter 240 is inserted into the penetration hole 215 to be closely attached to the bottom surface of the recess 214. A depth d2 of the recess 214 may be greater than a thickness of the supporting plate 242, such that the supporting plate 242 of the supporter 240 is positioned at the same height as or lower than the base portion 211 that forms the overall flat surface of the bottom 210a. Accordingly, when viewed in a cross-section, a top surface of the supporting plate 242 is disposed at the same height as or lower than the top surface of the base portion 211. As a result, the supporting plate 242 is flatly covered by the reflective sheet 250, undesirable scattering and reflection of light due to the supporting plate 242 is prevented. In addition, the reflective sheet 250 is prevented from protruding and being lifted near the supporting plate 242.

The reflective sheet 250 is positioned on the bottom chassis 210. The reflective sheet 250 allows light emitted from the optical lens 230 and light reflected by other structures, such as the diffuser 261, to be reflected and directed toward the LCD panel 100, thereby improving optical efficiency.

The entire reflective sheet 250 may be mounted on an inner surface of the bottom chassis 210. For example, the reflective sheet 250 may include a flat portion 250a, a wing 250b extending from an edge of the flat portion 250a in a substantially slanted and upward direction, and a rim 250c extending substantially horizontally from the wing 250b, such that they respectively correspond to the bottom 210a, the wing 210b, and the rim 210c of the bottom chassis 210. The reflective sheet 250 may be formed of a plastic material such as polyethylene terephthalate (PET), polycarbonate (PC), or polystyrene (PS). The reflective sheet 250 may include a light reflective material, such as titanium dioxide TiO₂, to increase light reflectance.

The flat portion 250a of the reflective sheet 250 is formed with a first hole 253 through which the optical lens 230 can pass and a second hole 254 through which the supporting portion 241 of the supporter 240 can pass. Accordingly, when the reflective sheet 250 is mounted onto the bottom chassis 210, as shown in FIG. 3, the optical lens 230 is exposed above the reflective sheet 250 through the first hole 253, and the supporting portion 241 is exposed above the reflective sheet 250 through the second hole 254. However, a part of the substrate 221 where the optical lens 230 is not positioned is covered by the reflective sheet 250. The supporting plate 242 of the supporter 240 is also covered by the reflective sheet 250. Accordingly, an entire inner surface of the bottom chassis 210 where the optical lens 230 and the supporting portion 241 of the supporter do not protrude above the reflective sheet 250 is covered by the reflective sheet 250. A space defined by the reflective sheet 250 and the diffuser 261, as described later, is herein referred to as an optical space of the backlight unit 200.

The first hole 253 may have a shape that corresponds to a horizontal cross-sectional shape of the optical lens 230, and may have, for example, a circular shape. The first hole 253 may be of a size through which a thickest part (i.e., part having the largest cross-sectional area) of the optical lens 230 can pass.

The second hole 254 may have a shape that corresponds to a horizontal cross-sectional shape of the supporting portion 241. For example, the second hole 254 may have a circular shape if the supporting portion 241 has a circular horizontal cross-sectional shape, and the second hole 254 may have a quadrangular shape if the supporting portion 241 has a quadrangular horizontal cross-sectional shape. The second hole 254 may be of a size through which the thickest part of the supporting portion 241 can pass. For example, when the second hole 254 and the supporting portion 241 have a circular horizontal cross-sectional shape, an inner diameter of the second hole 254 is the same as or nearly the same as an outer diameter of the thickest part of the supporting portion 241.

A vicinity of the first hole 253 through which the optical lens 230 passes may be lifted up in the flat portion 250a of the reflective sheet 250. In this case, the lifted part has an adverse effect on a profile of the light transmitted through the optical sheet 260 to be provided to the LCD panel 100 because it reflects light differently than the rest of the flat portion 250a. For example, the light may be displayed as being locally brighter or darker on the entire light emitting surface. Accordingly, to prevent the reflective sheet 250 from being lifted, the vicinity of the first hole 253 may be attached to the substrate 221 or the base portion 211 of the bottom chassis 210 by a double-sided adhesive tape (not shown) or an adhesive.

The optical sheet 260 is positioned above the bottom chassis 210 and the reflective sheet 250. Accordingly, the optical sheet 260 is positioned above the light source 222, the optical lens 230, and the supporter 240. An edge of the optical sheet 260 may be placed on the rim 210c of the bottom chassis 210. In this case, the rim 250c of the reflective sheet 250 may be positioned between the edge of the optical sheet 260 and the rim 210c of the bottom chassis 210. The optical sheet 260 is supported by the supporting portion 241 of the supporter 240 protruding through the second hole 254 of the reflective sheet 250 and therefore does not droop while maintaining a predetermined optical path.

The optical sheet 260 may include a diffuser 261, a prism sheet 262, a protecting sheet 263, and the like. The diffuser 261 is used to scatter light to produce a surface light source of uniform brightness. The prism sheet 262 is used to control the traveling direction of the light such that the light is concentrated, thereby improving luminance. The protecting sheet 263 is used to protect a prism of the prism sheet 262 from being scratched and the like. Further, the protecting sheet 263 may widen a viewing angle that is narrowed by the prism sheet 262.

The optical sheet 260 may exclude one of the prism sheet 262 and the protecting sheet 263, while including a plurality of the others. The optical sheet 260 may further include an optical sheet having characteristics other than those described above. For example, the optical sheet 260 may include a reflective polarizer sheet that improves luminance efficiency by separating, transmitting, and reflecting polarization components of the light.

Though not illustrated, an inverter board and/or a printed circuit board (PCB) for signal conversion and supplying power may be mounted as a printed circuit board (PCB) on a lower surface of the bottom chassis 210. The inverter board converts an external power supply into a constant voltage level and supplies it to the light source 222. The printed circuit board (PCB) for signal conversion may convert an analog data signal into a digital data signal and transmit it to the LCD panel 100 through the flexible printed circuit board attached to the LCD panel 100.

The LCD may include a mold frame 300 in which the LCD panel 100 is stably fixed onto the backlight unit 200 with a predetermined height therebetween. The mold frame 300 may be a square frame of a substantial cuboidal shape with top and bottom sides open. The mold frame 300 may be combined with the bottom chassis 210. For example, the mold frame 300 may be hooked and fixed to a hook (not shown) and the like that are positioned in the wall 210d of the bottom chassis 210 and enclose the rim 210c of the bottom chassis 210. In this case, a part of the mold frame 300 presses the edge of the optical sheet 260 that is placed on the rim 210c of the bottom chassis 210, so movement of the optical sheet 260 may be limited. The LCD panel 100 is fixed onto the mold frame 300. The LCD panel 100 may be attached to the flat surface of the mold frame 300 through an adhesion member (not shown), which may be a double-sided cushion tape with impact-absorbing capability for cushioning an impact applied to the LCD panel 100.

In a backlight unit 200 having the aforementioned structure, a process of supplying light to an LCD panel 100 is now briefly described. First, when power is supplied to a light source 222 through a connecting board 223 and a substrate 221, the light source 222 emits light. The emitted light is refracted and diffused to lateral sides while passing through an optical lens 230 and is reflected by a reflective sheet 250 toward an optical sheet 260. Some of the light emitted from the optical lens 230 may be directly directed toward the optical sheet 260. Then, the light is diffused while being transmitted through the optical sheet 260, and its direction of travel is controlled, thereby supplying the light to an entire surface of the LCD panel 100.

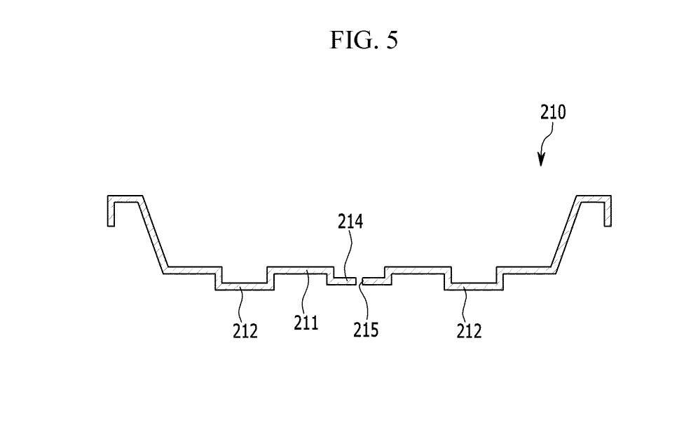

An assembling process of a backlight unit according to an exemplary embodiment of the present disclosure is now described with reference to FIGS. 5 to 9.

FIGS. 5 to 9 are schematic diagrams for illustrating an assembly process of a backlight unit according to an exemplary embodiment of the present disclosure.

In FIGS. 5 to 9, two light source assemblies of a bottom chassis 210 and one supporter 240 installed therebetween are illustrated, and they are relatively exaggerated, but it should be understood that this is only to simplify description of the assembling sequence and the relation of respective components, as well as to avoid an overly complicated drawing.

Referring to FIG. 5, a bottom chassis 210 is prepared. In the bottom chassis 210, a groove 212 for mounting a light source assembly and a recess 214 for mounting a supporter 240 are formed. The groove 212 and the recess 214 may have corresponding shapes and depths to accommodate the substrate 221 of the light source assembly. The recess 214 may have a corresponding shape to accommodate a supporting plate 242 of a supporter 240. A penetration hole 215 through which a hook 243 of the supporter 240 may be inserted is formed in the recess 214.

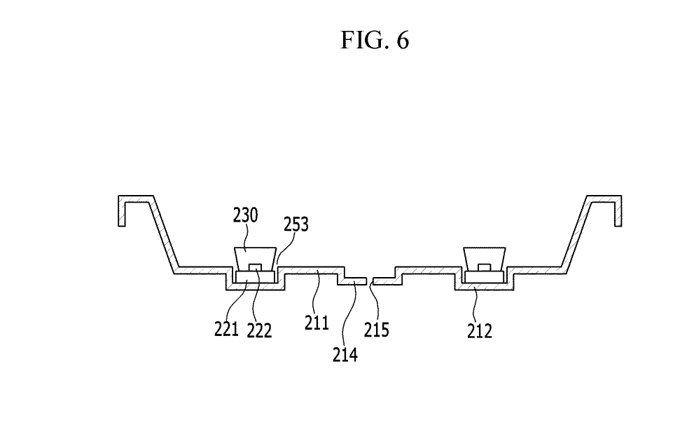

Referring to FIG. 6, the light source assembly is mounted on the groove 212 of the bottom chassis 210. The light source assembly includes a substrate 221, and a light source 222 and an optical lens 230 that are mounted on the substrate 221. Since the groove 212 of the bottom chassis 210 is formed to have a depth greater than a thickness of the substrate 221, the substrate 221 does not protrude beyond a base portion 211 of the bottom chassis 210 after the light source assembly is mounted on the groove 212.

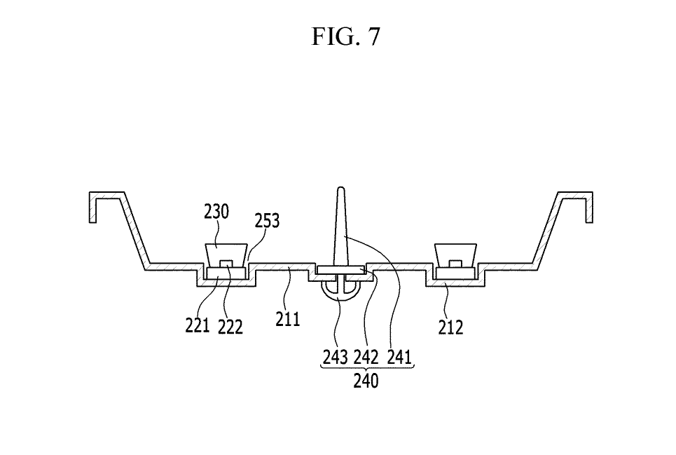

Referring to FIG. 7, the supporter 240 is mounted on the recess 214 of the bottom chassis 210. Mounting of the supporter 240 may be performed by pushing the hook 243 into the penetration hole 215 that is provided in the recess 214. The hook 243 is stopped by a bottom surface of the recess 214 after passing through the penetration hole 215, and in this case, the supporting plate 242 is closely attached to a top surface of the recess 214. Accordingly, as a locking portion of the supporter 240, the supporting plate 242 and the hook 243 are interlocked with the top and bottom surfaces of the recess 214 to fix the supporter 240 to the bottom chassis 210. In some exemplary embodiments, the hook 243 may be inserted into the penetration hole 215 such that it is tightly fitted into the penetration hole 215 and is fixed thereto. Since the recess 214 of the bottom chassis 210 is formed to have a depth greater than a thickness of the supporting plate 242, the supporting plate 242 does not protrude beyond the base portion 211 of the bottom chassis 210 after the supporter 240 is mounted on the recess 214.

When the locking portion has a structure of the supporting plate 242 and the hook 243, the supporter 240 may be locked with the bottom chassis 210 by pushing the hook 243 into the penetration hole 215 that is provided in the bottom chassis 210. Accordingly, compared with other locking means, such as, a bolt and nut, a screw, an adhesive, etc., assembly time may be reduced, and the supporter 240 can be easily separated when being disassembled for repair.

In some exemplary embodiments, the supporter 240 is described to be mounted after mounting the light source assembly, but the light source assembly may be mounted after mounting the supporter 240.

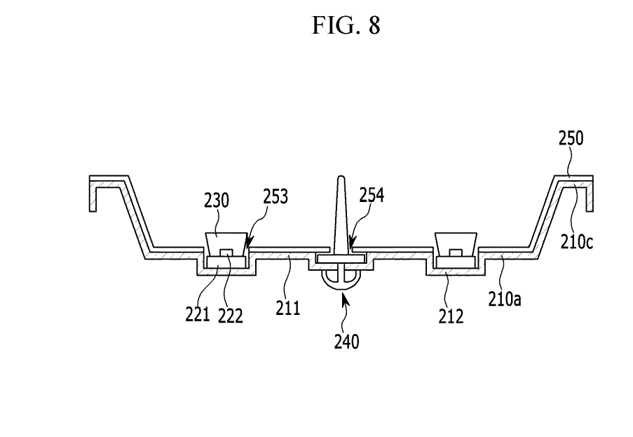

Referring to FIG. 8, a reflective sheet 250 is placed on the bottom chassis 210. A first hole 253 through which the optical lens 250 can pass and a second hole 254 through which the supporting portion 241 of the supporter 240 can pass are formed in reflective sheet 250. When placing the reflective sheet 250 on the bottom chassis 210, it should be correctly positioned. Since the second hole 254 of the reflective sheet 250 is formed to correspond to the supporting portion 241, and the supporting portion 241 protrudes from the bottom 210a of the bottom chassis 210, the reflective sheet 250 may be correctly positioned by simply fitting the second hole 254 into the supporting portion 241. When a plurality of supporters 240 are provided in the bottom chassis 210, the plurality of supporting portions 241 can be used as a guide so that the reflective sheet 250 is correctly placed at an exact location.

Since the supporting portion 241 of the supporter 240 serves as an installation guide of the reflective sheet 250, there is no need to form an additional guide protrusion and an additional hole in the reflective sheet 250 to correctly position the bottom chassis 210. If the guide protrusion and the additional hole are formed, the guide protrusion is not covered by the reflective sheet 250, but is exposed by the additional hole, so the guide protrusion may look relatively darker due to a difference in reflectance between the guide protrusion and the reflective sheet 250. According to the exemplary embodiment of the present disclosure, the guide protrusion and the additional hole are not formed, so the aforementioned problems do not occur.

As described above, after mounting the supporter 240, the reflective sheet 250 is placed on the bottom chassis 210 using the supporting portion 241 of the supporter 240 as the guide. After the reflective sheet 250 is placed thereon, the optical lens 230 is placed above the reflective sheet 250 through the first hole 253, and the supporting portion 241 is placed above the reflective sheet 250 through the second hole 254. As such, except for exposed portions above the reflective sheet 250 through the first and second holes 253 and 254, an inner surface of the bottom chassis 210 and the components mounted thereon (e.g., the substrate 221 of the light source assembly and the supporting plate 242 of the supporter) may be completely covered by the reflective sheet 250. In addition, since the substrate 221 mounted with the optical lens 230 and the supporting plate 242 of the supporter 240 are respectively accommodated in the groove 212 and the recess 214, the reflective sheet 250 may have an overall flat surface with no protruding or lifted parts. Accordingly, the exposed portions above the reflective sheet 250 can be minimized to reduce unnecessary light scattering, so the reflective sheet 250 reflects the light uniformly.

Prior to the installation of the reflective sheet 250, an adhesion member, such as a double-sided adhesive tape, may be applied around the first hole 253. In this case, since the reflective sheet 250 is attached to the bottom chassis 210 or the substrate 221 after the installation of the reflective sheet 250, lifting of the reflective sheet 250 is prevented.

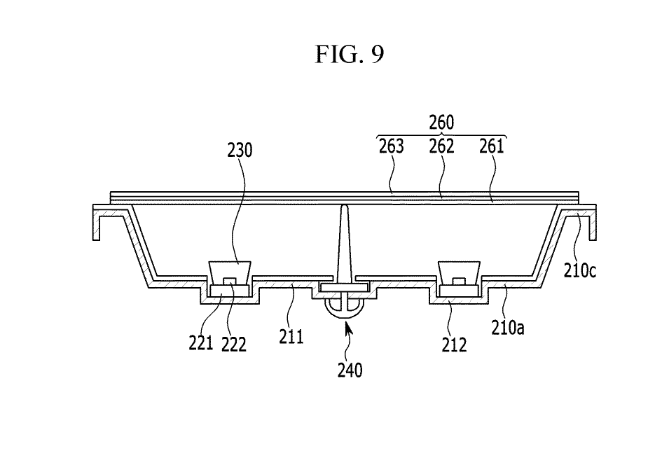

Referring to FIG. 9, an edge of the optical sheet 260 is placed on the rim 210c of the bottom chassis 210 to be supported thereby. In this case, an inner part of the optical sheet 260 may be supported by the supporting portion 241 of the supporter 240. Accordingly, the optical sheet 260 does not droop and uniformly maintains a predetermined distance with the light source 222.

A mold frame 300 may be mounted on the backlight unit 200 in which the bottom chassis 210 are assembled with the light source assembly, the supporter 240, the reflective sheet 250, and the optical sheet 260. In addition, an LCD may be assembled by placing an LCD panel 100 on the mold frame 300 and then installing a top chassis 400 to enclose an edge of the LCD panel 100.

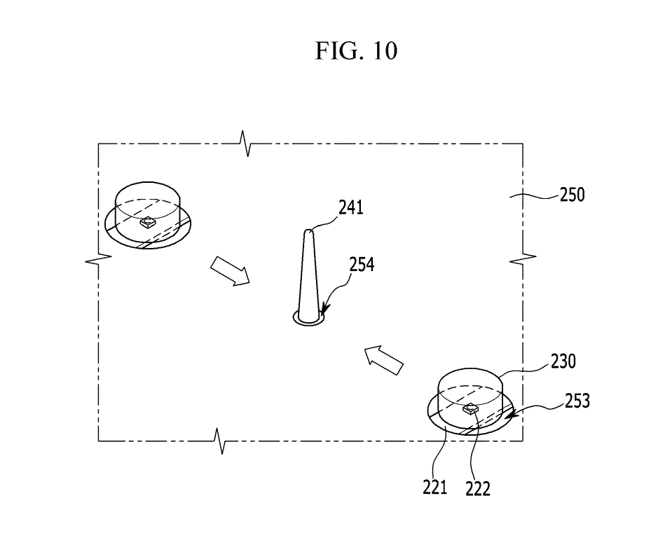

Optical characteristics of cases in which the supporting plate 242 of the supporter 240 is positioned below and above the reflective sheet 250 inside the recess 214 according to exemplary embodiments of the present disclosure are now described with reference to FIGS. 10 to 15.

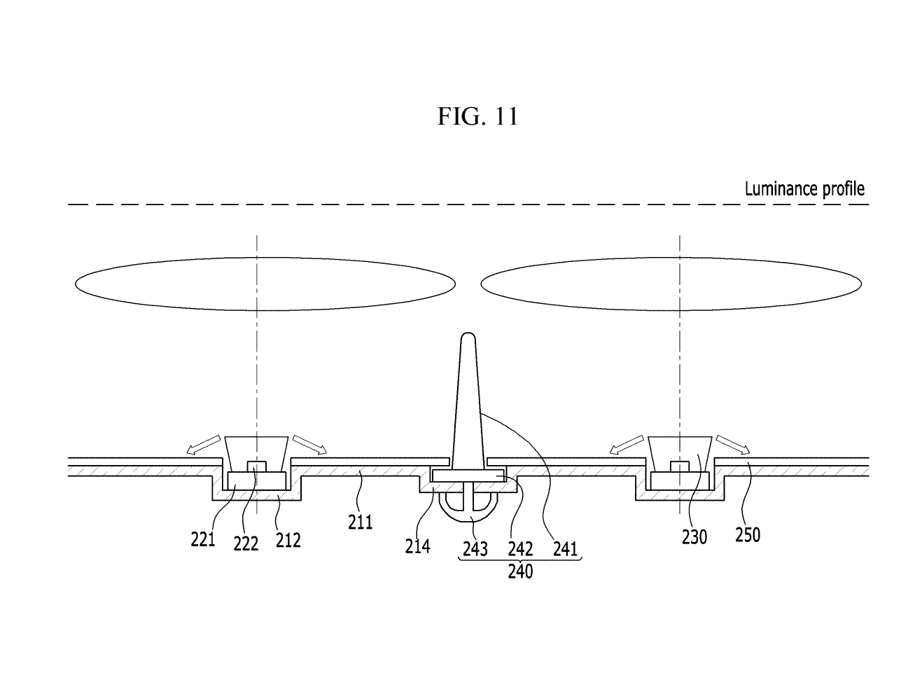

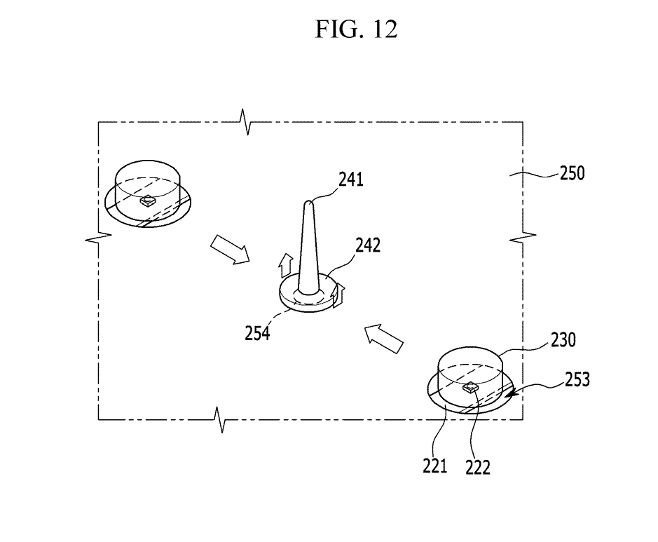

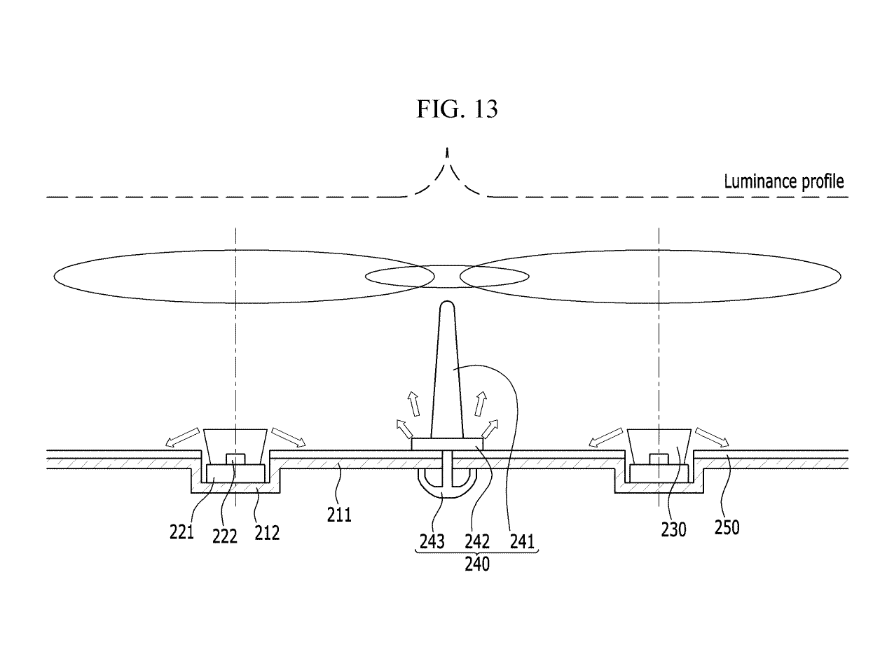

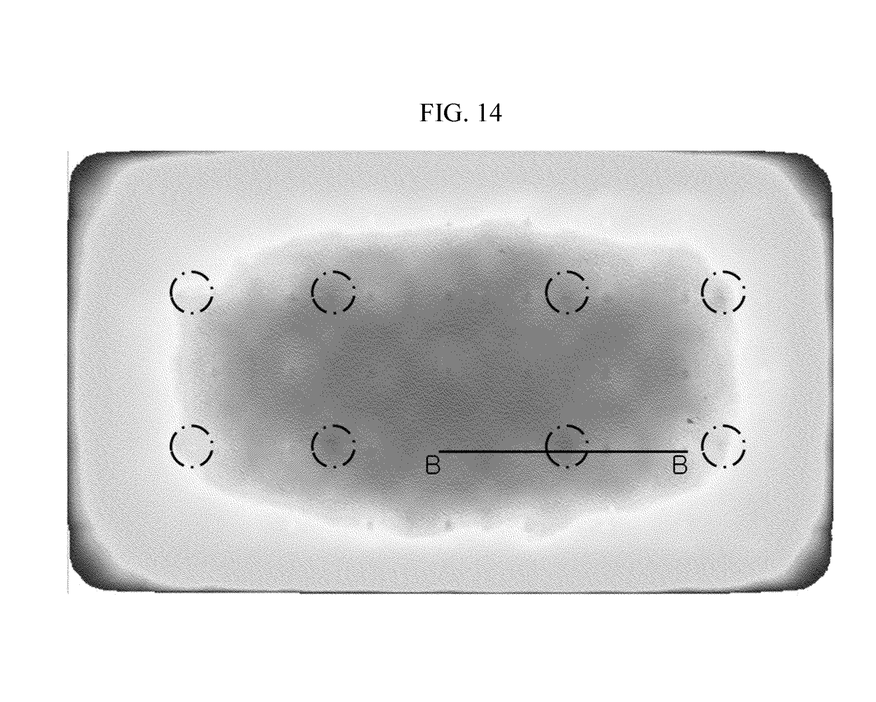

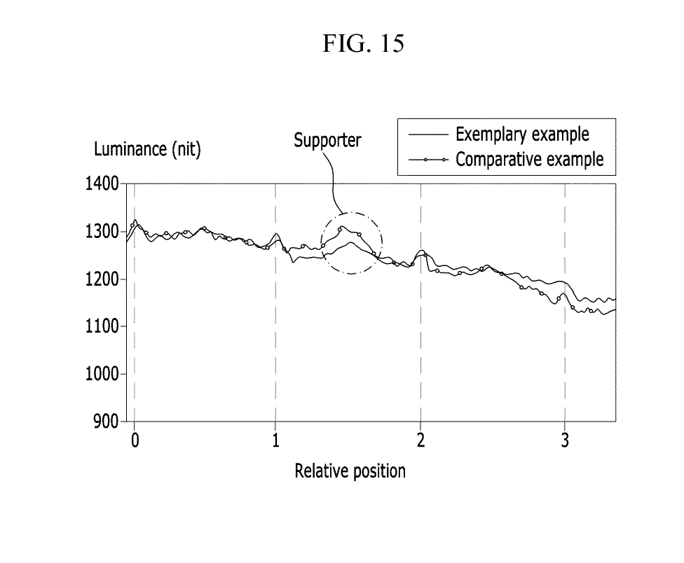

FIGS. 10 and 11 are drawings that illustrate light reflectance and a luminance profile of the backlight unit according to an exemplary embodiment of the present disclosure. FIGS. 12 and 13 are drawings that illustrate light reflectance and a luminance profile of a backlight unit according to a comparative example. FIG. 14 is a drawing that illustrates luminance distribution of light emitted from a backlight unit according to an exemplary embodiment of the disclosure. FIG. 15 is a graph illustrating a luminance profile of a B-B region of FIG. 14 together with that of a comparative example.

Referring to FIGS. 10 and 11, when light emitted from the light source 222 is transmitted through the optical lens 230, which in this case is a side emitting lens, it is refracted toward sides of the optical lens 230. The light refracted toward the sides of the optical lens 230 is partially directed toward the supporter 240. Since the supporting portion 241 of the supporter 240 protrudes above the reflective sheet 250, the supporting portion 241 may scatter the light. However, since the supporting plate 242 of the supporter 240 is positioned lower than the reflective sheet 250, light scattering is not caused by the supporting plate 242. As a result, luminance does not significantly increase near the supporter 240, and a relatively uniform luminance profile is obtained.

Unlike the aforementioned exemplary embodiment, in comparative examples illustrated in FIGS. 12 and 13, both the supporting portion 241 and the supporting plate 242 of the supporter 240 are exposed above the reflective sheet 250. In this case, the supporting plate 242 may be useful to prevent the reflective sheet 250 from being lifted because it is operated to press the reflective sheet 250, but uniformity of the luminance profile deteriorates due to light scattering that is caused by the exposed supporting plate 242. The light emitted from the sides of the optical lens 230 to be directed toward the supporter 240 may be scattered upward by the supporting plate 242, and therefore the luminance where the supporter 240 is positioned increases, as shown in FIG. 13.

FIG. 14 is a drawing that illustrates a luminance distribution of light emitted from the backlight unit 200 according to an exemplary embodiment of the present disclosure. In the luminance distribution, the light emitted above the optical sheet 260 of backlight unit 200 is photographed by a camera, and parts with relatively high luminance are represented by red, and parts with relatively low luminance are represented by blue. In other words, the luminance is higher closer to red and is lower closer to blue. In this case, the backlight unit 200 has a total of 45 light sources 222 arranged in a matrix form and 8 supporters 240 arranged at predetermined intervals. There are virtually no differences observed in luminance between centers of circled portions and vicinities thereof in the drawing.

FIG. 15 illustrates a luminance profiles corresponding to the solid B-B line shown in FIG. 14 for an exemplary embodiment and a comparative example. In the drawing, dotted lines represent positions of the light sources 222, while a digit on a horizontal axis represents a relative location of the light source 222 from a center column of the backlight unit 200. As described above, in the exemplary embodiment, the supporting plate 242 of the supporter 240 is positioned lower than the reflective sheet 250, and is covered by the reflective sheet 250. As shown in the graph of FIG. 15, a point where the supporter 240 is positioned shows slightly higher luminance than a vicinity thereof. Presumably, this is because the light scattering due to the supporting portion 241 of the supporter 240 has caused local luminance to increase to a certain degree.

Further, in FIG. 15, a luminance profile of the comparative example in which the supporting plate 242 of the supporter 240 is positioned above the reflective sheet 250 is shown, while the other conditions that are the same as in the exemplary embodiment of FIG. 14 are represented by an alternated long and short dash line. In this case, the luminance of points where the supporting bodies 240 are positioned are relatively higher than the vicinities thereof, and an overall luminance profile is not as uniform as the exemplary embodiment of FIG. 14. In other words, when the supporting plate 242 of the supporter 240 is positioned in the recess 214 of the bottom chassis 210, and the supporting plate 242 is positioned to cover the reflective sheet 250, in accordance with an exemplary embodiment of the present disclosure, the light scattering due to the supporting plate 242 does not occur, thereby minimizing the unnecessary light scattering by the supporter 240. Accordingly, the luminance increase generated near the supporter 240 is minimized.

While the present system and method have been described in connection with exemplary embodiments, it is to be understood that the present system and method are not limited to the disclosed embodiments. On the contrary, the present system and method cover various modifications and equivalent arrangements included within the spirit and scope of the appended claims.

What is claimed is:

1. A backlight unit comprising:
a bottom chassis;
a light source disposed on the bottom chassis;
a reflective sheet disposed on the bottom chassis;
at least one optical sheet disposed above the light source and the reflective sheet; and
a supporter fixed to the bottom chassis and supporting the optical sheet,
wherein the supporter includes a locking portion fastened to the bottom chassis and a supporting portion extending from the locking portion, and
wherein the locking portion is disposed below the reflective sheet.

2. The backlight unit of claim 1, wherein
the locking portion includes:
a supporting plate positioned between the bottom chassis and the reflective sheet; and
a hook penetrating the bottom chassis to be at least partially positioned below the bottom chassis.

3. The backlight unit of claim 2, wherein
the bottom chassis includes:
a substantially flat base portion; and
a recess downwardly depressed further than the base portion and in which the supporting plate is positioned,
wherein a depth of the recess is the same as or greater than a thickness of the supporting plate.

4. The backlight unit of claim 3, wherein
a top surface of the supporting plate is positioned at the same height as or lower than a top surface of the base portion.

5. The backlight unit of claim 1, wherein
the reflective sheet includes a hole through which the support portion passes.

6. The backlight unit of claim 1, further comprising:
a substrate on which the light source is mounted,
wherein the substrate is fixed to the bottom chassis and positioned lower than the reflective sheet.

7. The backlight unit of claim 6, wherein
the bottom chassis includes:
a substantially flat base portion; and
a groove downwardly depressed further than the base portion and in which the substrate is positioned,
wherein a depth of the groove is the same as or greater than a thickness of the substrate.

8. The backlight unit of claim 7, wherein
a top surface of the substrate is positioned at the same height as or lower than that of the base portion.

9. The backlight unit of claim 6, wherein
the reflective sheet is attached to the substrate through an adhesive.

10. The backlight unit of claim 6, further comprising:
a side emitting lens attached to the substrate and positioned to cover the light source.

11. The backlight unit of claim 1, wherein
the optical sheet includes a diffuser.

12. A manufacturing method of a backlight unit comprising:
preparing a bottom chassis;
fixing a light source unit including a light source to the bottom chassis;
fixing a supporter to the bottom chassis such that the supporter supports at least one optical sheet; and
placing a reflective sheet on the bottom chassis using at least a portion of the supporter as a guide after fixing the supporter.

13. The manufacturing method of claim 12, wherein
the supporter includes a locking portion fastened to the bottom chassis and a supporting portion extending from the locking portion,
wherein the reflective sheet includes a hole that is formed at a corresponding position of the support portion, and
wherein the placing of the reflective sheet on the bottom chassis includes fitting the hole into the support portion.

14. The manufacturing method of claim 13, wherein
the light source unit includes a substrate and a light source mounted on the substrate, and
wherein the placing of the reflective sheet on the bottom chassis includes attaching the reflective sheet to the substrate.

15. A display device comprising a display panel and a backlight unit for supplying light to the display panel, wherein the backlight unit includes:
a bottom chassis;
a light source disposed on the bottom chassis;
a reflective sheet disposed on the bottom chassis;
at least one optical sheet disposed above the light source and the reflective sheet; and
a supporter fixed to the bottom chassis and supporting the optical sheet,
wherein the supporter includes a locking portion fastened to the bottom chassis and a supporting portion extending from the locking portion, and
wherein the locking portion is disposed lower than the reflective sheet.

16. The display device of claim 15, wherein
the locking portion includes:
a supporting plate positioned between the bottom chassis and the reflective sheet; and
a hook penetrating the bottom chassis to be at least partially positioned below the bottom chassis.

17. The display device of claim 16, wherein
the bottom chassis includes:
a substantially flat base portion; and
a recess downwardly depressed further than the base portion and in which the supporting plate is positioned,
wherein a depth of the recess is the same as or greater than a thickness of the supporting plate.

18. The display device of claim 17, wherein
a top surface of the supporting plate is positioned at the same height as or lower than a top surface of the base portion.

19. The display device of claim 15, wherein
the reflective sheet includes a hole through which the support portion passes.

20. The display device of claim 15, wherein
the backlight unit further includes a substrate on which the light source is mounted,
wherein the substrate is fixed to the bottom chassis and positioned lower than the reflective sheet.

21. The display device of claim 20, wherein
the bottom chassis includes:
a substantially flat base portion; and
a groove downwardly depressed further than the base portion and in which the substrate is positioned,
wherein a depth of the groove is the same as or greater than a thickness of the substrate.

22. The display device of claim 21, wherein
a top surface of the substrate is positioned at the same height as or lower than that of the base portion.

23. The display device of claim 20, wherein
the reflective sheet is attached to the substrate through an adhesive.

24. The display device of claim 20, wherein
the backlight unit further includes a side emitting lens attached to the substrate and positioned to cover the light source.

25. The display device of claim 15, wherein
the optical sheet includes a diffuser.
